(19) United States
(12) Patent Application Publication
(10) Pub. No.: US 2009/0325441 A1
(43) Pub. Date: Dec. 31, 2009

(54) FLAME RETARDED TEXTILE PRODUCTS AND A METHOD OF MAKING THE SAME

(75) Inventors: Manon Loos, Corbais (BE); Danielle F. Goossens, Nodebais (BE); Eric-Jack Gerard, Gesves (BE)

Correspondence Address: ALBEMARLE CORPORATION;PATENT DEPARTMENT, 451 FLORIDA STREET, BATON ROUGE, LA, 70801, US

(73) Assignee: Albemarle Corporation, Baton Rouge, LA (US)

(21) Appl. No.: 12/438,814

(22) PCT Filed: Sep. 4, 2007
(86) PCT No.: PCT/US07/77508

§ 371 Date: Feb. 25, 2009

Related U.S. Application Data
(60) Provisional application No. 60/824,935, filed on Sep. 8, 2006.

(51) Int. Cl. C09K 21/12; B32B 5/02

(52) U.S. Cl. 442/144; 252/608

(57) ABSTRACT

Textile products having a flame retarded coating wherein the flame retarded coating contains a flame-retarding agent.

### FIELD OF THE INVENTION

The present invention relates to a textile product having a flame retarded coating.

### BACKGROUND OF THE INVENTION

Generally, commercial textile products are required by law to have flame retardant properties in order to help prevent flame spread in the event of a fire. Therefore, in many applications, commercial textile products consist of at least two distinct components, a textile material and a back-coating material. The back-coating material, sometimes referred to as a backing layer or blocking sheet, is used to impart flame retardant properties to a given textile product. For instance, transportation upholstery material is used in conjunction with separate fire blocking sheet layers. As a further example, many carpets include secondary or tertiary backing layers that have flame retardant properties.

In order to provide for such flame-retarded textiles, it has been proposed to use a variety of materials to provide the backing material or blocking sheet with flame retardant properties. For example, U.S. Pat. No. 7,011,724 teaches that intumescent particles can be used in the back-coating of carpet to provide the carpet with flame-retardant properties.

In other prior art teachings, specific brominated or phosphorous-based flame retardants are described as being useful towards providing blends of cotton and polyester fibers with flame retardant properties. For example, see U.S. Pat. Nos. 3,997,699 and 4,167,603.

In other teachings, the textile product itself is comprised of fibers having flame retardant or smoke suppressant properties, for example see U.S. Pat. No. 4,012,546.

However, even with these teachings, the textile industry's demand for flame retardant products is increasing. Thus, there is constantly a need in the art for flame retarded textiles.

### SUMMARY OF THE INVENTION

The present invention relates to a textile product having affixed thereto a flame retarding amount of:

i) Flame Retardant I, which comprises a major portion of an alkylated triaryl phosphate ester having the structure:

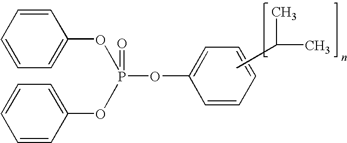

wherein n is in the range of from about 1 to about 3;

ii) Flame Retardant II, which comprises a major portion of:

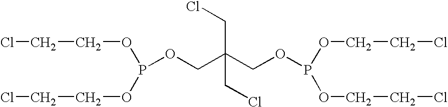

iii) Flame Retardant III, comprising a major portion of:

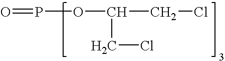

iv) Flame Retardant IV, having the structure:

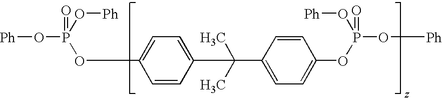

wherein z is in the range of from about 1 to about 4 and Ph is a phenol group; and,
v) mixtures of i)-iv).

In another embodiment, the present invention relates to a textile product having a coating layer deposited thereon, said coating layer containing a flame retarding amount of i) Flame Retardant I, ii) Flame Retardant II, iii) Flame Retardant III, iv) Flame Retardant IV, and v) mixtures of i)-iv).

In yet another embodiment, the present invention relates to a textile product having a back-coating containing a flame retarding amount of i) Flame Retardant I, ii) Flame Retardant II, iii) Flame Retardant III, iv) Flame Retardant IV, and v) mixtures of i)-iv).

In yet another embodiment, the present invention relates to a textile product having reduced flame spread characteristics comprising a textile material and a coating applied to a surface of said textile material and forming a layer thereon, said coating comprising a flame retarding amount of i) Flame Retardant I, ii) Flame Retardant II, iii) Flame Retardant III, iv) Flame Retardant IV, and v) mixtures of i)-iv).

In still yet another embodiment, the present invention relates to a method of imparting flame retardancy to a textile comprising affixing to said textile a coating comprising a flame retarding amount of i) Flame Retardant I, ii) Flame Retardant II, iii) Flame Retardant III, iv) Flame Retardant IV, and v) mixtures of i)-iv).

In still yet another embodiment, the present invention relates to a textile product comprising a flame retarding amount of i) Flame Retardant I, ii) Flame Retardant II, iii) Flame Retardant III, iv) Flame Retardant IV, and v) mixtures of i)-iv).

The inventors hereof have discovered a flame retarding amount of i) Flame Retardant I, ii) Flame Retardant II, iii) Flame Retardant III, iv) Flame Retardant IV, and v) mixtures of i)-iv), preferably Flame Retardant II, Flame Retardant III, or mixtures thereof, does not substantially affect the quality of the textile product. In other words, the textile product containing the flame retarding amount of i), ii), iii), iv), or v) does not have any malodorous smell, i.e. the textile product containing the flame retarding amount of i), ii), iii), iv), or v) smells similar, preferably substantially the same, as the same textile product that does not contain the flame retarding amount of i), ii), iii), iv), or v). Further, the textile product containing the flame retarding amount of i), ii), iii), iv), or v) has physical properties such as pliability and softness similar, preferably substantially the same, as the same textile product that does not contain the flame retarding amount of i), ii), iii), iv), or v).

The inventors hereof have also discovered that if the flame retarding amount of i) Flame Retardant I, ii) Flame Retardant II, iii) Flame Retardant III, iv) Flame Retardant IV, and v) mixtures of i)-iv), preferably Flame Retardant II, Flame Retardant III, or mixtures thereof, is used as a coating, preferably a back coating, on a textile product, the coating is substantially transparent.

### DETAILED DESCRIPTION OF THE INVENTION

Textile, as used herein, is used in its broadest sense and is meant to refer to any fabric, filament, staple, or yarn, or products made therefrom, which may be woven or non-woven and all fabrics, cloths, carpets, etc. made from synthetic and/or natural fibers especially polyamides, acrylics, polyesters, and blends thereof, cellulosic textile material, including cotton, corduroy, velvet brocade, polyester-cotton blends, viscose rayon, jute, and products made from wood pulp. Non-limiting examples of textiles suitable for use in the present invention thus include natural and/or synthetic carpets; fabrics and/or cloths made from synthetic fibers such as polyesters, polyamides, nylons, acrylics, etc.; fabrics and/or cloths made from natural fibers such as cotton; and fabrics and/or cloths made from blends of synthetic fibers and natural fibers such as cotton/polyester blends. It should be noted that it is also within the scope of the present invention that, in some embodiments, the natural and/or synthetic fibers that make up the textiles of the present invention also be flame retarded. Such flame-retarded fibers are well known in the art, and the selection of such a fiber is readily achievable by one having ordinary skill in the art.

As used herein, “IP's” is meant to refer to isopropylatedphenols; “OIP” is meant to refer to ortho-isopropylphenol; “MIP” is meant to refer to meta-isopropylphenol; “PIP” is meant to refer to para-isopropylphenol; “TPP” is meant to refer to triphenyl phosphate; “2,6-DIP” is meant to refer to 2,6-diisopropylphenol; “2,4-DIP” is meant to refer to 2,4-diisopropylphenol; “2,4,6-TIP” is meant to refer to 2,4,6-triisoproplylphenol; “2-IPP” is meant to refer to 2-isopropylphenyl diphenyl phosphate; “3-IPP” is meant to refer to 3-isopropylphenyl diphenyl phosphate; “4-IPP” is meant to refer to 4-isopropylphenyl diphenyl phosphate; “2,4-DDP” is meant to refer to 2,4-diisopropylphenyl diphenyl phosphate; “IPP's” is meant to refer to isopropylated triphenyl phosphates; “DTPP” is meant to refer to diisopropylated triphenyl phosphate; and “TTPP” is meant to refer to triisopropylated triphenyl phosphate.

The textiles of the present invention have affixed thereto a flame retarding amount of i) Flame Retardant I, ii) Flame Retardant II, iii) Flame Retardant III, iv) Flame Retardant IV, and v) mixtures of i)-iv). By a flame retarding amount, it is meant that the textile comprises in the range of from about 5 to about 60 wt. % of the selected flame retardant, i.e. i) Flame Retardant I, ii) Flame Retardant II, iii) Flame Retardant III, iv) Flame Retardant IV, and v) mixtures of i)-iv), based on the total weight of the flame retarded textile. In preferred embodiments, a flame retarding amount is to be considered in the range of from about 15 to about 40 wt. %, more preferably in the range of from about 25 to about 30 wt. %, of the selected flame retardant, on the same basis.

### Flame Retardant I

Flame Retardant I, comprises a major portion of an alkylated triaryl phosphate ester having the structure:

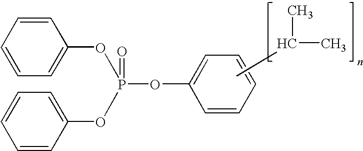

wherein n is in the range of from about 1 to about 3. By a major portion, it is meant that Flame Retardant I comprises greater than about 60 wt. %, based on the total weight of Flame Retardant I, of the above-illustrated alkylated triaryl phosphate esters. In preferred embodiments, a major portion is to be considered in the range of from about 60 to about 99.99 wt. % of the above-illustrated structure. In some embodiments, a major portion is in the range of from about 60 to about 80 wt. % of the above-illustrated structure. In other embodiments, a major portion is in the range of from about 80 to about 99 wt. % of the above-illustrated structure. In still other embodiments, a major portion is in the range of from about 85 to about 99.99 wt. % of the above-illustrated structure.

The remainder of Flame Retardant I typically comprises triphenyl phosphate (“TPP”). Thus, in preferred embodiments, Flame Retardant I comprises less than about 40 wt. % TPP, based on the weight of Flame Retardant I, preferably in the range of from about 40 to about 0.01 wt. %, TPP, on the same basis, etc.

Typically Flame Retardant I contains from about 5 to about 10 wt % organic phosphorous, based on the total weight of Flame Retardant I. Preferably, the organic phosphorus content ranges from about 7 to about 9 wt %, on the same basis, and in more preferred embodiments the organic phosphorous content ranges from about 7.5 to about 8.5 wt %, most preferably in the range of from about 8.0 to about 8.4%, on the same basis.

In some embodiments, Flame Retardant I can be further characterized as containing greater than about 20 wt % monalkylphenyl diphenyl phosphates, based on the total weight of Flame Retardant I. Preferably, Flame Retardant I contains greater than about 75 wt %, on the same basis, monalkylphenyl diphenyl phosphates, more preferably greater than about 90 wt %, on the same basis.

In this embodiment, Flame Retardant I can also be further characterized as containing less than about 80 wt % di-(alkylphenyl)phenyl phosphates, based on the total weight of Flame Retardant I. Preferably Flame Retardant I contains less than about 25 wt %, more preferably less than about 10 wt %, di-(alkylphenyl)phenyl phosphates, on the same basis.

Flame Retardant I can also be further characterized as containing less than about 50 wt %, based on the total weight of Flame Retardant I, dialkylphenyl diphenyl phosphates. However, in preferred embodiments, Flame Retardant I contains less than about 25 wt %, more preferably less than about 10 wt %, dialkylphenyl diphenyl phosphates, on the same basis. In a most preferred embodiment, Flame Retardant I contains less than about 1 wt %, based on the total weight of Flame Retardant I, dialkylphenyl diphenyl phosphates.

In this embodiment, exemplary alkylated triaryl phosphate esters used as Flame Retardant I are those that comprise: a) in the range of from about 90 to about 92 wt. % IPP, in the range of from about 0.5 to about 0.75 wt. % TPP, in the range of from about 1 to about 3 wt. % DTPP, in the range of from about 0.05 to about 0.15 wt. % TTPP, and in the range of from about 0.5 to about 0.75 wt. % 2,4-DDP; b) in the range of from about 94 to about 96 wt. % IPP, in the range of from about 3.5 to about 5.5 wt. % DTPP, and in the range of from about 0.1 to about 0.3 wt. % TTPP; and c) in the range of from about 71 to about 73 wt. % IPP, in the range of from about 0.05 to about 0.15 wt. % TPP, in the range of from about 26 to about 28 wt. % DTPP, and in the range of from about 0.5 to about 0.7 wt. % TTPP.

Monoalkylphenyl diphenyl phosphates, di-(alkylphenyl)phenyl phosphates, dialkylphenyl diphenyl phosphates, trialkylphenyl phosphates, and alkylphenyl dialkylphenyl phenyl phosphates, present in the alkylated triaryl phosphate esters of the present invention are those wherein the alkyl moieties are selected from methyl, ethyl, propyl, isopropyl, butyl, isobutyl, tertiary-butyl, amyl, isoamyl, tertiary-amyl groups, and cyclohexyl alkyl moieties. Preferably, the alkyl moieties of at least one of, preferably at least two of, more preferably all of, the monoalkylphenyl diphenyl phosphates, di-(alkylphenyl)phenyl phosphates, dialkylphenyl diphenyl phosphates, trialkylphenyl phosphates, and alkylphenyl dialkylphenyl phenyl phosphates, present in the alkylated triaryl phosphate esters are isopropyl moieties. Thus, for example, in a most preferred embodiment, Flame Retardant I is a isopropylphenyl diphenyl phosphate ester. Of the total isopropylphenyl diphenyl phosphate esters, 0.1 to 99.9 wt % is 2-isopropylphenyl phosphate (2-IPP), 0.1 to 99.9 wt % is 3-isopropylphenyl phosphate (3-IPP), 0.1 to 99.9 wt % is 4-isopropylphenyl phosphate (4-IPP), all based on the total weight of the alkylated triaryl phosphate ester. In the most preferred embodiments 66 to 100 wt % of the isopropylphenyl phenyl phosphate present in Flame Retardant I is 2-isopropylphenyl phosphate (2-IPP), 0.1 to 4-wt % is 3-isopropylphenyl phosphate (3-IPP), 0.1 to 40 wt % is 4-isopropylphenyl phosphate (4-IPP).

In this embodiment, another exemplary Flame Retardant I is an isopropylphenyl diphenyl phosphate ester wherein in the range of about 63 to about 68% of the isopropylphenyl diphenyl phosphate ester is 2-IPP, in the range of from about 0.5 to about 2.5% is 3-IPP and in the range of from about 30.5 to about 36.5% is 4-IPP. In this embodiment, another exemplary Flame Retardant I is an isopropylphenyl diphenyl phosphate esters wherein about 66% of the isopropylphenyl diphenyl phosphate ester is 2-IPP, about 1% is 3-IPP and about 33% is 4-IPP.

The alkylated triaryl phosphate esters of the present invention can suitably be formed by any process known in the art including that of U.S. Provisional Application No. 60/794,786.

### Flame Retardant II

Flame Retardant II comprises a major portion of:

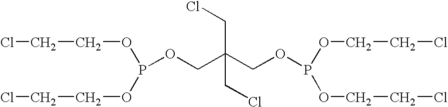

By a major portion, it is meant that Flame Retardant II comprises greater than about 60 wt. %, based on the total weight of Flame Retardant II, of the above-illustrated structure. In preferred embodiments, a major portion is to be considered in the range of from about 60 to about 99.99 wt. % of the above-illustrated structure. In some embodiments, a major portion is in the range of from about 60 to about 90 wt. % of the above-illustrated structure. In other embodiments, a major portion is in the range of from about 70 to about 99 wt. % of the above-illustrated structure. In still other embodiments, a major portion is in the range of from about 80 to about 99 wt. % of the above-illustrated structure.

In some embodiments, Flame Retardant II can also comprise in the range of from about 0.01 to about 6 wt. %, preferably in the range of from about 0.01 to about 2 wt. %, of:

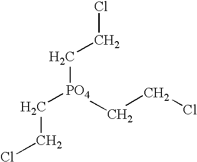

which is commonly referred to as TCEP, based on the total weight of Flame Retardant II including the TCEP.

In some embodiments, Flame Retardant II can also comprise TCEP and in the range of from about 1 to about 15 wt. %, preferably in the range of from about 5 to about 12 wt. %, more preferably in the range of from about 8 to about 12 wt. %, of:

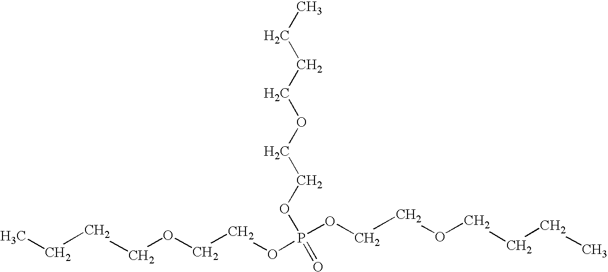

which is commonly referred to as TBEP, based on the total based on the total weight of Flame Retardant II, including the TCEP and TBEP. Thus, in this embodiment, Flame Retardant II comprises a major portion of:

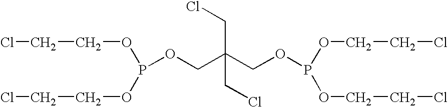

in the range of from about 0.01 to about 6 wt. %, preferably in the range of from about 0.01 to about 2 wt. %, of TCEP and in the range of from about 1 to about 15 wt. %, preferably in the range of from about 5 to about 12 wt. %, more preferably in the range of from about 8 to about 12 wt. %, of TBEP, all based on the total weight of Flame Retardant II including the TBEP and TCEP.

Typically Flame Retardant II contains from about 5 to about 15 wt % organic phosphorous, based on the total weight of Flame Retardant II. Preferably, the organic phosphorus content is in the range of from about 7 to about 12 wt %, on the same basis, and in more preferred embodiments the organic phosphorous content is in the range of from about 8 to about 12 wt %, on the same basis.

Typically Flame Retardant II contains in the range of from about 20 to about 40 wt % chlorine, based on the total weight of Flame Retardant II. Preferably, Flame Retardant II contains in the range of from about 30 to about 40 wt %, of chlorine, on the same basis.

### Flame Retardant III

Flame Retardant III, comprises a major portion of:

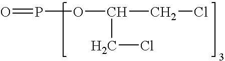

By a major portion, it is meant that Flame Retardant III comprises greater than about 60 wt. %, based on the total weight of Flame Retardant III, of the above-illustrated structure. In preferred embodiments, a major portion is to be considered greater than about 80 wt. % of the above-illustrated structure. In some embodiments, a major portion is in the range of from about 70 to about 99.99 wt. %, sometimes in the range of from about 80 to about 99 wt. % of the above-illustrated structure.

In some embodiments, Flame Retardant III can also comprise in the range of from about 10 to about 60 wt. %, preferably in the range of from about 15 to about 55 wt. %, more preferably in the range of from about 20 to about 30 wt. %, of A):

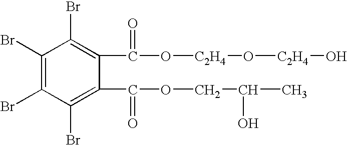

all based on the total weight of the combination of Flame Retardant III including A).

In some embodiments, Flame Retardant III can also comprise in the range of from about 1 to about 10 wt. %, preferably in the range of from about 5 to about 10 wt. %, based on the total weight of Flame Retardant III, of Flame Retardant I, all based on the total weight of Flame Retardant III including Flame Retardant I.

In some embodiments, Flame Retardant III can also comprise in the range of from about 1 to about 15 wt. %, preferably in the range of from about 5 to about 12 wt. %, B):

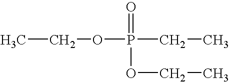

all based on the total weight of Flame Retardant III, including A) and B). Thus, in this embodiment, Flame Retardant III comprises a major portion of:

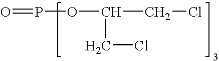

in the range of from about 10 to about 60 wt. %, preferably in the range of from about 15 to about

55 wt. %, more preferably in the range of from about 20 to about 30 wt. %, of A), and in the range of from about 1 to about 15 wt. %, preferably in the range of from about 5 to about 12 wt. %, B), all based on the total weight of Flame Retardant III including A) and B).

Typically Flame Retardant III contains in the range of from about 5 to about 15 wt % organic phosphorous, based on the total weight of Flame Retardant III. Preferably, the organic phosphorus content is in the range of from about 5 to about 12 wt %, on the same basis, and in more preferred embodiments the organic phosphorous content is in the range of from about 5 to about 10 wt %, on the same basis.

Flame Retardant III typically has a total halogen, i.e. bromine and/or chlorine, content in the range of from about 30 to about 50 wt % total halogen, based on the total weight of Flame Retardant III (including A) and/or B) or otherwise). However, it is preferred that Flame Retardant III contain in the range of from about 40 to about 50 wt %, of total halogen, on the same basis.

### Flame Retardant IV

Flame Retardant IV comprises:

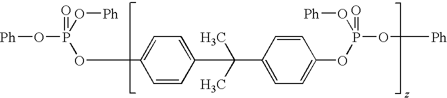

wherein z is in the range of from about 1 to about 4 and Ph is a phenol group.

Typically Flame Retardant IV contains in the range of from about 5 to about 15 wt % organic phosphorous, based on the total weight of Flame Retardant IV. Preferably, the organic phosphorus content is in the range of from about 5 to about 10 wt %, on the same basis, and in more preferred embodiments the organic phosphorous content is in the range of from about 7 to about 10 wt %, on the same basis.

### Mixtures of Flame Retardant I-IV

In the practice of the present invention, Flame Retardant I, Flame Retardant II, Flame Retardant III, and Flame Retardant IV can be used individually. However, in other embodiments, it is within the scope of the present invention that any of Flame Retardant I, Flame Retardant II, Flame Retardant III, and Flame Retardant IV be used in combination with another of Flame Retardant I, Flame Retardant II, Flame Retardant III, and Flame Retardant IV. For example, Flame Retardant I can be used in combination with any or all of Flame Retardant II, Flame Retardant III, and Flame Retardant IV; Flame Retardant II can be used in combination with any or all of Flame Retardant I, Flame Retardant III, and Flame Retardant IV; etc.

### Method of Application to Textile

The method by which the designated flame retardant is applied to the textile is not critical to the instant invention and can be selected from any method known in the art to be effective at applying a flame-retarding agent to a textile. For instance, the selected flame retardant can be dispersed and/or applied to the textile by methods such as the “coating” methods commonly used in the art, i.e. back-coating, spraying, dipping, soaking, etc.

However, in a preferred embodiment, the selected flame retardant is contained in a layer such as a backing, back layer, or back-coating, referred to collectively herein as back-coating, that is applied to a surface of the textile. The back-coating is typically derived from a polymer compound and a suitable liquid carrier material in which the selected flame retardant is dispersed. The liquid carrier material can be any suitable liquid carrier material commonly used in producing back-coatings such as organic liquids and water. In preferred embodiments, the liquid carrier material is water.

The selection of the polymer used in the back-coating is readily achievable by one having ordinary skill in the art. Typically the polymer of the back-coating can be selected from any of a large number of stable polymeric dispersions known and used for binding, coating, impregnating or related uses, and may be of a self crosslinking type or externally crosslinked type. The polymeric constitutent can be an addition polymer, a condensation polymer or a cellulose derivative. Non-limiting examples of suitable polymers include foamed or unfoamed organosols, plastisols, latices, and the like, which contain one or more polymeric constituents of types which include vinyl halides such as polyvinyl chloride, polyvinyl chloride-polyvinyl acetate and polyethylene-polyvinyl chloride; polymers and copolymers of vinyl esters such as polyvinyl acetate, polyethylene-polyvinyl and polyacrylic-polyvinyl acetate; polymers and copolymers of acrylate monomers such as ethyl acrylate, methyl acrylate, butyl acrylate, ethylbutyl acrylate, ethylhexyl acrylate, hydroxyethyl acrylate and dimethylaminoethyl acrylate; polymers and copolymers of methacrylate monomers such as methyl methacrylate, ethyl methacrylate, isopropyl methacrylate and butyl methacrylate; polymers and copolymers of acrylonitrile, methacrylonitrile, acrylamide, N-iso-propylacrylamide, N-methylolacrylamide and methacrylamide; vinylidene polymers and copolymers such as polyvinylidene chloride, polyvinylidene chloride-polyvinyl chloride, polyvinylidene chloride-polyethyl acrylate and polyvinylidene chloride-polyvinyl chloride-polyacrylonitrile; polymers and copolymers of olefin monomers including ethylene and propylene as well as polymers and copolymers of 1,2-butadiene, 1,3-butadiene, 2-ethyl-1,3-butadiene, and the like; natural latex; polyurethanes, polyamides; polyesters; polymers and copolymers of styrene including styrene, 2-methylstyrene, 3-methylstyrene, 4-methylstyrene, 4-ethylstyrene, and 4-butylstyrene; phenolic emulsions; aminoplast resins and the like. The use of such polymers in back-coating textiles is well-known in the art, for example, see U.S. Pat. Nos. 4,737,386 and 4,304,812.

In preferred embodiments, the polymer of the back-coating is either a polymer latex or a polymer plastisol compound, more preferably a polymer latex. In some embodiments, the latex polymer used for the back-coating includes a polyvinylidene chloride copolymer with at least one acrylic monomer. Standard acrylic monomers include, for example, acrylic acid, methacrylic acid, esters of these acids, or acrylonitrile, ethyl acrylate, butylacrylate, glycidyl methacrylate, N-methylolacrylamide, acrylonitrile, 2-hydroxyethyl acrylate, ethylene dimethacrylate, vinyl acetate, butyl acetate, and the like. Alternatively, the backcoating may comprise conventional thermoplastic polymers, which can be applied to the textile by hot melt techniques known in the art.

The back-coating can optionally include additional components, such as other fire retardants, synergists, dyes, wrinkle resist agents, foaming agents, buffers, pH stabilizers, fixing agents, stain repellants such as fluorocarbons, stain blocking agents, soil repellants, wetting agents, softeners, water repellants, stain release agents, optical brighteners, emulsifiers, thickeners, and surfactants. However, in preferred embodiments, synergists such as Sb₂O₃ are not used.

The back-coating is typically formed by combining the polymer, liquid carrier material, optional components, if any, and selected flame retardant in any manner and order known, and the method and order is not critical to the instant invention. For example, these components, both optional and otherwise, could be mixed together in a storage vessel, etc.

Further, the back-coating can be applied to the surface of the textile through any means known in the art. For example, the use of coating machines such as those utilizing pressure rolls and chill rolls can be used, “knife” coating methods, by extrusion, coating methods, transfer methods, coating, spraying, foaming or the like. The amount of back-coating applied to the textile is generally that amount sufficient to provide for a textile having a flame retarding amount of the designated flame retardant, as described above. After application of the back-coating, the back-coating can be cured on the textile by heating or drying or in any way reacting the back-coating.

The above description is directed to several embodiments of the present invention. Those skilled in the art will recognize that other means, which are equally effective, could be devised for carrying out the spirit of this invention. It should also be noted that preferred embodiments of the present invention contemplate that all ranges discussed herein include ranges from any lower amount to any higher amount. The following examples will illustrate the present invention, but are not meant to be limiting in any manner.

### EXAMPLES

In the following examples, the effectiveness of a back-coating containing Flame Retardants I-IV, as indicated in the Tables, as a flame retardant for fabrics, as indicated, is described. In these Examples, FR is used as an abbreviation for Flame Retardant, i.e. Flame Retardant I can be abbreviated as FR I, etc.

First, a dispersion containing the selected flame retardant was prepared, and was subsequently used to prepare a back-coating that was applied to the polyester/acrylic fabric.

The flame retardant efficacy of the selected flame-retardant-containing back-coating was measured with the British Standard 5852, part 1 {small flame 20 second ignition) before and after water soaking (British Standard 5651).

These examples demonstrate that back-coatings containing Flame Retardant I-IV can be prepared and applied to fabrics without problems, and these back-coated fabrics pass the BS5852 test at an add-on levels as indicated in the Tables. Further, these back-coated fabrics do not lose any weight and pass the BS5852 test after the water soaking test (British Standard 5651), which make back-coatings containing Flame Retardant I-IV suitable for use in upholstered furniture applications.

### Example

### 1. Preparation of the Flame Retardant-Containing Dispersion (FR Dispersion)

In order to form a dispersion, 145.2 g water was placed in a plastic vessel equipped with a four-leaf stirrer. Under constant stirring, 2.15 g of Suparex K, a dispersant commercially available from Clariant, was added to the water. After the complete mixing of the water and Suparex K, 2.95 g of Alcopol OPG, a wetting agent commercially available from Ciba Specialty Chemicals, was then added to the mixture in the cup along with 345.1 g of the selected Flame Retardant. After the addition of all of the components, the speed of the stirrer was increased to 1500 rpm, and the contents of the vessel were mixed for 2-3 minutes.

4.6 g of Texigel®, a polyacrylate thickener available commercially from Scott Bader Ltd., were then added to the contents of the vessel under constant mixing. The viscosity of the dispersion should be in the range of from about 2000 to about 6000 cP. If the viscosity is too low, the amount of Texigel® can be increased, if the viscosity is too high, water can be added. The viscosity was easily measured with a Brookfield (DV-E) viscometer.

The amount of each component in the dispersion is contained in Table 1 below. It should be noted that FR is used synonymously with the selected Flame Retardant. Also, wet wt. % is based on the total weight of the dispersion.

TABLE 1
Formulation for the FR dispersion

| | TSC (Total | Dry pphr (parts | | |
|---|---|---|---|---|
| Material | Solid Content) | per hundred FR) | Wet pphr | Wet wt. % |
| Water | 0 | — | 42.7 | 29.04 |
| Suparex K (dispersant) | 100 | 0.62 | 0.62 | 0.43 |
| Alcopol (wetting agent) | 70 | 0.6 | 0.86 | 0.59 |
| Selected Flame | 100 | 100 | 100 | 69.02 |
| Retardant | | | | |
| Texigel ® (thickener) | 15 | 0.2 | 1.33 | 0.92 |
| TOTAL | 70 | 101.42 | 144.88 | 100 |

### 2. Preparation of the Back-Coating

In order to form the back-coating, 129.8 g Vycar 460X46, a PVC emulsion binder commercially available from Noveon Performance Coatings, was introduced into a plastic vessel plastic vessel equipped with a four-leaf stirrer and gently stirred. To the plastic vessel under content stirring, 19.1 g of Santicizer® 141, a plasticizer commercially from Ferro Corporation, were added followed by 0.7 g of Suparex DE 104, an antifoaming agent available commercially from Clariant. After 2 minutes of stirring, 25.45 g of Viscalex® HV30, an acrylic thickener commercially available from Ciba Specialty Chemicals, were added along with 93.35 g of water followed by 4.45 g of ammonia (25%). After 5 minutes of constant stirring, 227 g of the Flame Retardant dispersion described in Table 1 is added. The speed of the stirrer was increased to 1500-2000 rpm, and the viscosity should be in the range of from about 7000 and 9000 cP. If the viscosity is too low, the amount of Viscalex® HV30 can be increased, if the viscosity is too high, Performax® 11115 can be added.

The amount of each component in the back-coating is contained in Table 2 below. It should be noted that FR is used synonymously with the selected-flame retardant. Also, wet wt. % is based on the total weight of the back-coating.

TABLE 2
Formulation for the Back-coating

| Material | TSC | Dry pphr | Wet pphr | Wet wt. % |
|---|---|---|---|---|
| Vycar (VC acrylate) | 49 | 100 | 204.08 | 25.96 |
| Santicizer 141 (plasticizer) | 100 | 30 | 30 | 3.82 |
| Suparex DE104 (antifoam) | 100 | 1.08 | 1.08 | 0.14 |
| Viscalex HV30 (thickener) | 30 | 12 | 40 | 5.09 |
| Water | 0 | — | 146.86 | 18.67 |
| Ammonia | 0 | — | 7 | 0.89 |
| FR dispersion | 70 | 250 | 357.14 | 45.43 |
| TOTAL | 50 | 393.08 | 786.16 | 100 |

### 3. Backcoating of the Fabric

The back-coating described in Table 2 and produced above was applied to a cotton chenille fabric having a fabric weight of 393 g/m². The back-coating was applied to the fabric by a Mathis labcoater type LTE-S, a “knife” coating machine. The fabric sample (33×43 cm) was fixed to the pin frame of the Mathis labcoater, and a knife was placed at the beginning of the fabric and the back-coating put close to the knife, which moves forward and coats the fabric. The coating speed and the coating thickness can be adjusted to obtain the desired amount of coating on the fabric. When the fabric is coated the pin frame automatically goes into an oven, and the time in the oven and temperature of the oven can be adjusted. In this example, the coated fabric was dried 5 min at 90° C. and 10 min at 140° C.

The percentage of back-coating (also called add on) and bromine content of the back-coated fabric were determined by using with the following formulas:

[[[(Weight of the coated fabric)/(L(cm)*W(cm) of the fabric)]*10000]−(weight of the uncoated fabric (g/m²)]=back-coating weight (g/m²) 1)

[(back-coating weight (g/m²)}/(weight of the uncoated fabric (g/m²))]*100=% of the back-coating on the fabric 2)

The percentage of Halogen or Phosphorous, as indicated, on the fabric is calculated with the following formula:

(% of the back-coating on the fabric)×(% FR dispersion in dry pphr in the back-coating)=% Halogenated or Phosphorous FR on the fabric 1)

(% Halogenated or Phosphorous FR on the fabric)×(% Halogenated or Phosphorous content in the FR)=% of Halogenated or Phosphorous on the fabric 2)

Using the above formulas, it was determined that the back-coating of the fabric resulted in the amount of back-coating on the fabric, and Halogen/Phosphorus content on the fabric as indicted in Tables 3 below.

After the application of the back-coating to the fabric, the back-coated fabric was subjected to the BS5852 (part one, match test, 20 second ignition) flame retardancy tests along with the BS5651 water soaking test. The results of these tests are contained in Table 3 below.

TABLE 3

| | | FR II and 1 wt. % | |
|---|---|---|---|
| | FR II and 0.1 wt. % | TCEP and 10 wt. % | FR III and 7 wt. % |
| | TCEP | TBEP | Aryl Phosphate |
| Add on (%) | 23/36.9 | 27.1/30.2 | 29.8 |
| Br content (%) | | | |
| Sb₂O₃ | NONE | NONE | NONE |
| content (%) | | | |
| Cl content (%) | 5.3/8.5 | 5.6/6.3 | 8.7 |
| Hal (Br + Cl) | | | |
| content (%) | | | |
| Phosphorus | 1.5/2.5 | 1.7/1.9 | 1.3 |
| content (%) | | | |
| BS5852 (flame | Pass(10 s)/Pass | Pass(10 s)/Pass(10 s) | Pass |
| test) | | | |
| % weight loss | 0 | 0 | 0 |
| after water | | | |
| soaking | | | |
| BS5852 after | Pass(10 s)/Pass(6 s) | Pass(10 s)/Pass(10 s) | Fail |
| water soaking | | | |

| | FR III and 22 wt. % | | | |
|---|---|---|---|---|
| | A and 9.5 wt. % | | | HBCD |
| | B | FR IV | FR I | (COMPARATIVE) |
| Add on (%) | 27.2/34.4 | 31 | 33 | 27.6 |
| Br content (%) | | | | 13 |
| Sb₂O₃ | NONE | NONE | NONE | NONE |
| content (%) | | | | |
| Hal (Br + Cl) | 7.5/9.5 | | | |
| content (%) | | | | |
| Phosphorus | 1.1/1.4 | 1.7 | 1.6 | |
| content (%) | | | | |
| BS5852 (flame | Fail/Pass | Fail | Pass | Pass (10 s) |
| test) | | | | |
| % weight loss | 0 | 0 | 0 | 0 |
| after water | | | | |
| soaking | | | | |
| BS5852 after | Pass (15 s) | Fail | Pass | Pass (10 s) |
| water soaking | | | | |

As demonstrated in the examples, most of the FR's used in the current invention pass the BS5852 flame test and water soaking test, making them effective FR's suitable for use in textile applications. Further, most of the FR's used in the current invention meet or exceed the performance of HBCD in both the BS5852 flame test and water soaking test, making them effective substitutes for HBCD in textile applications.

What is claimed:

1) A textile product comprising a flame retarding amount of:
i) Flame Retardant I, which comprises a major portion of an alkylated triaryl phosphate ester having the structure: 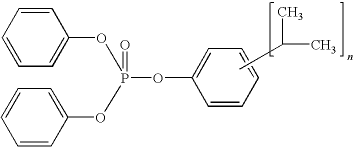
wherein n is in the range of from about 1 to about 3;
ii) Flame Retardant II, which comprises a major portion of: 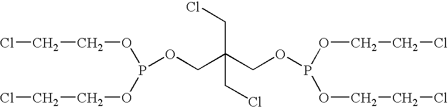
iii) Flame Retardant III, comprising a major portion of: 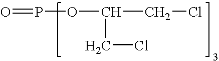
iv) Flame Retardant IV, having the structure: 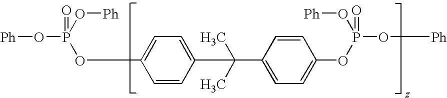
wherein z is in the range of from about 1 to about 4 and Ph is select a phenol.
and,
v) mixtures of i)-iv).

2) The textile product according to claim 1 wherein said textile product comprises a flame retarding amount of Flame Retardant I and Flame Retardant I comprises greater than about 60 wt. %, of the above-illustrated alkylated triaryl phosphate esters, less than about 40 wt. % TPP, and in the range of from about 5 to about 10 wt % organic phosphorous, all based on the total weight of Flame Retardant I.

3) The textile product according to claim 2 wherein Flame Retardant I comprises one or more of the following alkylated phenyl phosphates: a) monoalkylphenyl diphenyl phosphates; b) di-(alkylphenyl)phenyl phosphates; c) dialkylphenyl diphenyl phosphates; d) trialkylphenyl phosphates; e) alkylphenyl dialkylphenyl phenyl phosphates; and f) less than about 1 wt. % triphenyl phosphate, wherein the alkyl, methyl, ethyl, propyl, isopropyl, butyl, isobutyl, tertiary-butyl, amyl, moieties of the alkylated phenyl phosphates are selected isoamyl, tertiary-amyl groups, cyclohexyl and tertiary-amyl groups.

4) The textile product according to claim 3 wherein Flame Retardant I comprises greater than about 20 wt % monalkylphenyl diphenyl phosphates, less than about 80 wt % di-(alkylphenyl)phenyl phosphates, less than about 10 wt % di-(alkylphenyl)phenyl phosphates, less than about 20 wt % trialkylphenyl phosphate, and less than about 20 wt %, alkylphenyl dialkylphenyl phenyl phosphates, all based on the total weight of Flame Retardant I.

5) The textile product according to claim 1 wherein Flame Retardant I comprises:
a) in the range of from about 90 to about 92 wt. % IPP, in the range of from about 0.5 to about 0.75 wt. % TPP, in the range of from about 1 to about 3 wt. % DTPP, in the range of from about 0.05 to about 0.15 wt. % TTPP, and in the range of from about 0.5 to about 0.75 wt. % 2,4-DDP, all based on the total weight of Flame Retardant I; or
b) in the range of from about 94 to about 96 wt. % IPP, in the range of from about 3.5 to about 5.5 wt. % DTPP, and in the range of from about 0.1 to about 0.3 wt. % TTPP, all based on the total weight of Flame Retardant I; or,
c) in the range of from about 71 to about 73 wt. % IPP, in the range of from about 0.05 to about 0.15 wt. % TPP, in the range of from about 26 to about 28 wt. % DTPP, and in the range of from about 0.5 to about 0.7 wt. % TTPP, all based on the total weight of Flame Retardant I.

6) The textile product according to claim 1 wherein said textile product comprises a flame retarding amount of Flame Retardant II and Flame Retardant II comprises:
a) greater than about 60 wt. %, of: 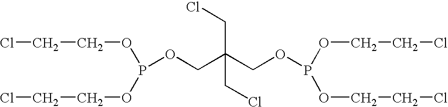
based on the total weight of Flame Retardant II, and, optionally,
b) in the range of from about 0.01 to about 6 wt. % of TCEP, has an organic phosphorus concentration in the range of from about 5 to about 15 wt %, and in the range of from about 20 to about 40 wt % chlorine, all based on the total weight of Flame Retardant II including the TCEP; or
c) in the range of from about 0.01 to about 6 wt. % of TCEP in the range of from about 1 to about 15 wt. % of TBEP, in the range of from about 20 to about 40 wt % chlorine, and has an organic phosphorus concentration in the range of from about 5 to about 15 wt %, all based on the total weight of Flame Retardant II including said TCEP and TBEP.

7) The textile product according to claim 1 wherein said textile product comprises a flame retarding amount of Flame Retardant III and Flame Retardant III comprises greater than about 60 wt. %, of: 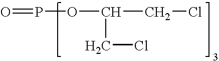
based on the total weight of Flame Retardant III,
wherein Flame Retardant III optionally has an organic phosphorus content in the range of from about 5 to about 15 wt % organic phosphorous, based on the total weight of Flame Retardant III and/or a total halogen, i.e. bromine and/or chlorine, content in the range of from about 30 to about 50 wt % total halogen, based on the total weight of Flame Retardant III.

8) The textile product according to claim 7 wherein Flame Retardant III comprises:
a) in the range of from about 10 to about 60 wt. %, of A): 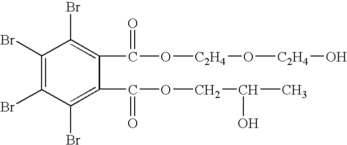
based on the total weight of Flame Retardant III including A); or
b) in the range of from about 10 to about 60 wt. %, of A) and in the range of from about 1 to about 15 wt. %, of B): 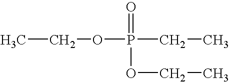
based on the total weight of Flame Retardant III including A) and B),
wherein a) or b) optionally has a total halogen, i.e. bromine and/or chlorine, content in the range of from about 30 to about 50 wt % total halogen, based on the total weight of a) or b), and/or in the range of from about 5 to about 15 wt % organic phosphorous, based on the total weight of a) or b).

9) The textile product according to claim 1 wherein said textile product comprises Flame Retardant IV and Flame Retardant IV contains in the range of from about 5 to about 15 wt % organic phosphorous, based on the total weight of Flame Retardant IV.

10) The textile product according to any of claim 1 wherein said textile product has odor and physical attributes similar to that of an identical textile product not containing a flame retarding amount of i) Flame Retardant I, ii) Flame Retardant II, iii) Flame Retardant III, iv) Flame Retardant IV, and v) mixtures of i)-iv).

11) The textile product according to claim 1 wherein the odor, pliability, and/or softness of said textile product containing said flame retarding amount of i) Flame Retardant I, ii) Flame Retardant II, iii) Flame Retardant III, iv) Flame Retardant IV, and v) mixtures of i)-iv) is substantially the same as an identical textile product that does not contain said flame retarding amount.

12) A textile product having a coating layer deposited thereon, said coating layer containing in the range of from about 5 to about 60 wt. % of a flame retardant selected from i) Flame Retardant I, ii) Flame Retardant II, iii) Flame Retardant III, iv) Flame Retardant IV, and v) mixtures of i)-iv).

13) The textile product according to claim 12 wherein said textile product is selected from fabrics, cloths, carpets, and the like made from synthetic and/or natural fibers.

14) The textile product according to claim 12 wherein said coating layer is a back-coating.

15) The textile product according to claim 12 wherein said textile product comprises a flame retarding amount of Flame Retardant I and Flame Retardant I comprises greater than about 60 wt. %, of the above-illustrated alkylated triaryl phosphate esters, less than about 40 wt. % TPP, and in the range of from about 5 to about 10 wt % organic phosphorous, all based on the total weight of Flame Retardant I.

16) The textile product according to claim 15 wherein Flame Retardant I comprises one or more of the following alkylated phenyl phosphates: a) monoalkylphenyl diphenyl phosphates; b) di-(alkylphenyl)phenyl phosphates; c) dialkylphenyl diphenyl phosphates; d) trialkylphenyl phosphates; e) alkylphenyl dialkylphenyl phenyl phosphates; and f) less than about 1 wt. % triphenyl phosphate, wherein the alkyl, methyl, ethyl, propyl, isopropyl, butyl, isobutyl, tertiary-butyl, amyl, moieties of the alkylated phenyl phosphates are selected isoamyl, tertiary-amyl groups, cyclohexyl and tertiary-amyl groups.

17) The textile product according to claim 16 wherein Flame Retardant I comprises:
a) greater than about 20 wt % monalkylphenyl diphenyl phosphates, less than about 80 wt % di-(alkylphenyl)phenyl phosphates, less than about 10 wt % di-(alkylphenyl)phenyl phosphates, less than about 20 wt % trialkylphenyl phosphate, and less than about 20 wt %, alkylphenyl dialkylphenyl phenyl phosphates, all based on the total weight of Flame Retardant I; or
b) in the range of from about 90 to about 92 wt. % IPP, in the range of from about 0.5 to about 0.75 wt. % TPP, in the range of from about 1 to about 3 wt. % DTPP, in the range of from about 0.05 to about 0.15 wt. % TTPP, and in the range of from about 0.5 to about 0.75 wt. % 2,4-DDP, all based on the total weight of Flame Retardant I; or
c) in the range of from about 94 to about 96 wt. % IPP, in the range of from about 3.5 to about 5.5 wt. % DTPP, and in the range of from about 0.1 to about 0.3 wt. % TTPP, all based on the total weight of Flame Retardant I; or,
d) in the range of from about 71 to about 73 wt. % IPP, in the range of from about 0.05 to about 0.15 wt. % TPP, in the range of from about 26 to about 28 wt. % DTPP, and in the range of from about 0.5 to about 0.7 wt. % TTPP, all based on the total weight of Flame Retardant I.

18) The textile product according to claim 12 wherein said textile product comprises a flame retarding amount of Flame Retardant II and Flame Retardant II comprises:
a) greater than about 60 wt. %, of 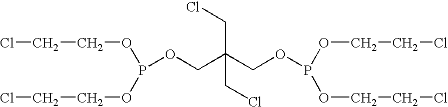
based on the total weight of Flame Retardant II; and, optionally,
b) in the range of from about 0.01 to about 6 wt. % of TCEP, in the range of from about 5 to about 15 wt % organic phosphorous, and in the range of from about 20 to about 40 wt % chlorine, all based on the total weight of Flame Retardant II including the TCEP; or
c) in the range of from about 0.01 to about 6 wt. % of TCEP, in the range of from about 1 to about 15 wt. % of TBEP, and in the range of from about 20 to about 40 wt % chlorine, all based on the total weight of Flame Retardant II including said TCEP and TBEP.

19) The textile product according to claim 12 wherein said textile product comprises a flame retarding amount of Flame Retardant III and Flame Retardant III comprises greater than about 60 wt. %, of: 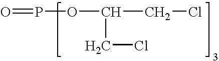
based on the total weight of Flame Retardant III,
wherein Flame Retardant III optionally has an organic phosphorus content in the range of from about 5 to about 15 wt % organic phosphorous, based on the total weight of Flame Retardant III and/or a total halogen, i.e. bromine and/or chlorine, content in the range of from about 30 to about 50 wt % total halogen, based on the total weight of Flame Retardant III.

20) The textile product according to claim 19 wherein Flame Retardant III comprises:
a) in the range of from about 10 to about 60 wt. %, of A): 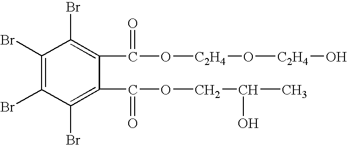
based on the total weight of Flame Retardant III including A); or
b) in the range of from about 10 to about 60 wt. %, of A) and in the range of from about 1 to about 15 wt. %, of B): 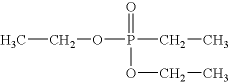
based on the total weight of Flame Retardant III including A) and B),
wherein a) or b) optionally has a total halogen, i.e. bromine and/or chlorine, content in the range of from about 30 to about 50 wt % total halogen, based on the total weight of a) or b), and/or in the range of from about 5 to about 15 wt % organic phosphorous, based on the total weight of a) or b).

21) The textile product according to claim 12 wherein said textile product comprises Flame Retardant IV and Flame Retardant IV contains in the range of from about 5 to about 15 wt % organic phosphorous, based on the total weight of Flame Retardant IV.

22) The textile product according to any of claim 12 wherein said textile product has odor and physical attributes similar to that of an identical textile product not containing a flame retarding amount of i) Flame Retardant I, ii) Flame Retardant II, iii) Flame Retardant III, iv) Flame Retardant IV, and v) mixtures of i)-iv).

23) The textile product according to claim 12 wherein the odor, pliability, and/or softness of said textile product containing said flame retarding amount of i) Flame Retardant I, ii) Flame Retardant II, iii) Flame Retardant III, iv) Flame Retardant IV, and v) mixtures of i)-iv) is substantially the same as an identical textile product that does not contain said flame retarding amount.

24) A method of imparting flame retardancy to a textile comprising affixing to said textile a coating comprising a flame retarding amount of a flame retardant selected from i) Flame Retardant I, ii) Flame Retardant II, iii) Flame Retardant III, iv) Flame Retardant IV, and v) mixtures of i)-iv), wherein said textile is selected from fabrics, cloths, carpets, and the like, made from synthetic and/or natural fibers.

25) A textile product having reduced flame spread characteristics comprising a textile material and a coating applied to a surface of said textile material and forming a layer thereon, said coating comprising in the range of from about 15 to about 40 wt. % of a flame retardant selected from i) Flame Retardant I, ii) Flame Retardant II, iii) Flame Retardant III, iv) Flame Retardant IV, and v) mixtures of i)-iv), wherein said textile product is selected from fabrics, cloths, carpets, and the like, made from a) synthetic fibers, b) natural fibers, or mixtures of a) and b), and said coating is a back coating, said back coating being substantially transparent and said textile product has odor and physical attributes similar to that of an identical textile product not containing a flame retarding amount of i) Flame Retardant I, ii) Flame Retardant II, iii) Flame Retardant III, iv) Flame Retardant IV, and v) mixtures of i)-iv), wherein said textile product optionally includes fibers that are flame retarded.
